(19) United States
(12) Patent Application Publication
(10) Pub. No.: US 2014/0000417 A1
(43) Pub. Date: Jan. 2, 2014

(54) Metric and English Socket Wrench

(71) Applicant: ELANTEC INDUSTRIAL MFG. CO., LTD., Taichung City (TW)

(72) Inventor: Ying-Liang Lai, Taichung City (TW)

(73) Assignee: ELANTEC INDUSTRIAL MFG. CO., LTD., Taichung City (TW)

(21) Appl. No.: 13/664,707

(22) Filed: Oct. 31, 2012

(30) Foreign Application Priority Data
Jun. 28, 2012 (TW) 101123241

(51) Int. Cl. B25B 13/06

(52) U.S. Cl. 81/121.1

(57) ABSTRACT

A metric and English socket wrench is rotatable about an axis, and includes an inner peripheral surface. The inner peripheral surface has first engaging portions, and second engaging portions arranged alternately with the first engaging portions. Each of the first engaging portions has two first engaging surfaces interconnected to form a V-shape. A first apex is disposed between the two first engaging surfaces, and is spaced apart from the axis by a first distance. Each of the second engaging portions has two second engaging surfaces interconnected to form a V-shape. A second apex is disposed between the two second engaging surface, and is spaced apart from the axis by a second distance. Ratio of the first distance to the second distance is more than 0.94 and less than 1.06.

### CROSS-REFERENCE TO RELATED APPLICATION

This application claims priority of Taiwanese Application No. 101123241, filed on Jun. 28, 2012.

### BACKGROUND OF THE INVENTION

1. Field of the Invention

This invention relates to a hand tool, and more particularly to a metric and English socket wrench.

2. Description of the Related Art

Taiwanese Patent Publication No. 349458 discloses a tool suitable for metric and English systems. The hand tool has a tool head formed with a plurality of large driving grooves and a plurality of small driving grooves formed at an inner wall surface thereof for driving bolts or nuts. However, when the large driving grooves engage a bolt or a nut, the idle angle is relatively large, thereby resulting in substantial movement of the hand tool relative to the bolt or the nut. The minimum distance between each of the large driving grooves and an outer peripheral surface of the hand tool is much smaller than that between each of the small driving grooves and the outer peripheral surface of the hand tool, so that the strength of the hand tool is reduced, and the hand tool cannot meet the requirement of German DIN standard.

### SUMMARY OF THE INVENTION

The object of this invention is to provide a metric and English socket wrench that meets German DIN standard and that has a high strength.

According to this invention, a metric and English socket wrench is rotatable about an axis, and includes an inner peripheral surface. The inner peripheral surface has first engaging portions, and second engaging portions arranged alternately with the first engaging portions. Each of the first engaging portions has two first engaging surfaces interconnected to form a V-shape. A first apex is disposed between the two first engaging surfaces, and is spaced apart from the axis by a first distance. Each of the second engaging portions has two second engaging surfaces interconnected to form a V-shape. A second apex is disposed between the two second engaging surface, and is spaced apart from the axis by a second distance. Ratio of the first distance to the second distance is more than 0.94 and less than 1.06.

### BRIEF DESCRIPTION OF THE DRAWINGS

These and other features and advantages of this invention will become apparent in the following detailed description of the preferred embodiments of this invention, with reference to the accompanying drawings, in which:

FIG. 1 is a perspective view of the first preferred embodiment of a metric and English socket wrench according to this invention;

FIG. 2 is a top view of the first preferred embodiment;

FIG. 3 is a top view of the second preferred embodiment of a metric and English socket wrench according to this invention;

FIG. 4 is a top view of the third preferred embodiment of a metric and English socket wrench according to this invention; and

FIG. 5 is a top view of the fourth preferred embodiment of a metric and English socket wrench according to this invention.

### DETAILED DESCRIPTION OF THE PREFERRED EMBODIMENTS

Before the present invention is described in greater detail in connection with the preferred embodiments, it should be noted that similar elements and structures are designated by like reference numerals throughout the entire disclosure.

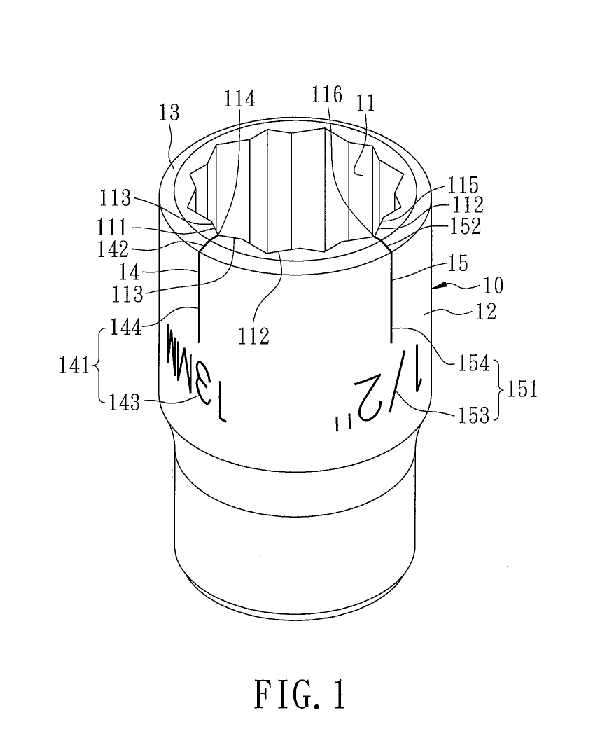

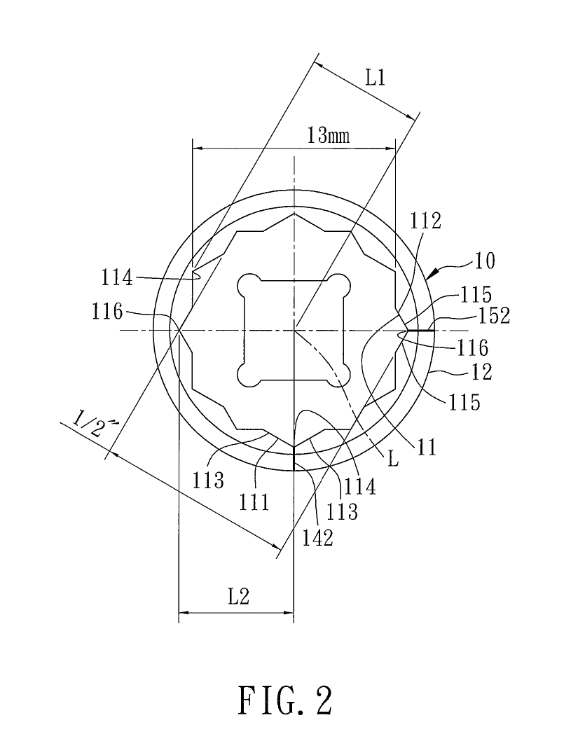

FIGS. 1 and 2 show the first preferred embodiment of a metric and English socket wrench according to this invention, which is rotatable about an axis (L) for driving 13 mm bolts or nuts, and 0.5 inch bolts or nuts. The socket wrench includes an inner peripheral surface 11, an outer peripheral surface 12 opposite to the inner peripheral surface 11, an end surface 13 connected between the inner peripheral surface 11 and the outer peripheral surface 12, a first indication unit 14, and a second indication unit 15.

The inner peripheral surface 11 has a plurality of circumferentially spaced-apart first engaging portions 111, and a plurality of second engaging portion 112 arranged alternately with the first engaging portions 111. Each of the first engaging portions 111 has two first engaging surfaces 113 interconnected to form a V-shape, such that a first apex 114 is disposed between the first engaging surfaces 113, and is spaced apart from the axis (L) by a first distance (L1). Each of the second engaging portions 112 has two second engaging surfaces 115 interconnected to form a V-shape, such that a second apex 116 is disposed between the second engaging surfaces 115, and is spaced apart from the axis (L) by a second distance (L2). The ratio of the first distance (L1) to the second distance (L2) is more than 0.94, and less than 1.06. In this embodiment, the first distance (L1) is 7.5056 mm, and the second distance (L2) is 7.3323 mm, so that the ratio of the first distance (L1) to the second distance (L2) is about 1.0235351.

The first indication unit 14 is aligned with one of the first engaging portions 111, and has a first marking portion 141 disposed on the outer peripheral surface 12, and a first connecting portion 142 extending from the first marking portion 141 toward the one of the first engaging portions 111. The first marking portion 141 includes a first size-indicating mark 143 and a first pointer line 144 extending from a top end of the outer peripheral surface 12 toward the first size-indicating mark 143. The first connecting portion 142 is linear, is disposed on the end surface 13, extends from a top end of the first pointer line 144, and is terminated at the first apex 114 of the one of the first engaging portions 111.

The second indication unit 15 is aligned with one of the second engaging portions 112, and has a second marking portion 151 disposed on the outer peripheral surface 12, and a second connecting portion 152 extending from the second marking portion 151 toward the one of the second engaging portions 112. The second marking portion 151 includes a second size-indicating mark 153 and a second pointer line 154 extending from a top end of the outer peripheral surface 12 toward the second size-indicating mark 153. The second connecting portion 152 is linear, is disposed on the end surface 13, extends from a top end of the second pointer line 154, and is terminated at the second apex 116 of the one of the second engaging portions 112.

As such, the first engaging portions 111 can be used to drive a metric system bolt or nut, and the second engaging portions 112 can be used to drive an English system bolt or nut. The positions of the first and second engaging portions 111, 112 and the sizes of the bolts or nuts to be driven by the first and second engaging portions 111, 112 can be indentified from the first and second indication units 14, 15.

The metric system sizes and the English system sizes of Bolts or nuts drivable by the socket wrench of this invention are listed in the following table. As shown in this table, each of the metric system sizes corresponds to one of the English system sizes.

| Metric system sizes (mm) | English system sizes (inch) |
|---|---|
| 6 | ¼ |
| 7 | 9/32 |
| 8 | 5/16 |
| 9 | 11/32 |
| 10 | ⅜ |
| 11 | 7/16 |
| 12 | ½ |
| 13 | ½ |
| 14 | 9/16 |
| 15 | ⅝ |
| 16 | ⅝ |
| 17 | 11/16 |
| 18 | 11/16 |
| 19 | ¾ |
| 21 | 13/16 |
| 22 | ⅞ |
| 24 | 15/16 |
| 26 | 1 |
| 27 | 1 + 1/16 |
| 28 | 1 + ⅛ |
| 29 | 1 + 3/16 |
| . | . |
| . | . |
| . | . |

Since the ratio of the first distance (L1) to the second distance (L2) is more than 0.94, and less than 1.06, the distance between each of the first apexes 114 and an outer peripheral surface 12 is approximate to that between each of the second apexes 116 and the outer peripheral surface 12, so that the strength of the hand tool is increased, and the hand tool can meet the requirement of German DIN standard.

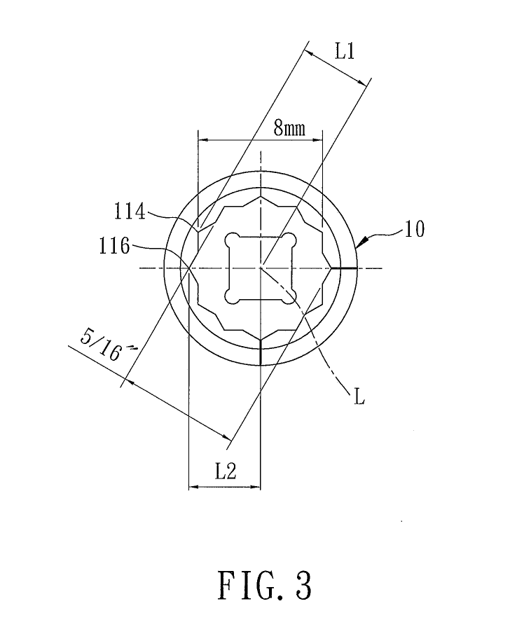

FIG. 3 shows the second preferred embodiment of a metric and English socket wrench according to this invention, which has a metric system size of 8 mm, and an English system size of 5/16 inch. In this embodiment, the first distance (L1) is 4.6501 mm, and the second distance (L2) is 4.5827 mm, so that the ratio of the first distance (L1) to the second distance (L2) is 1.0149.

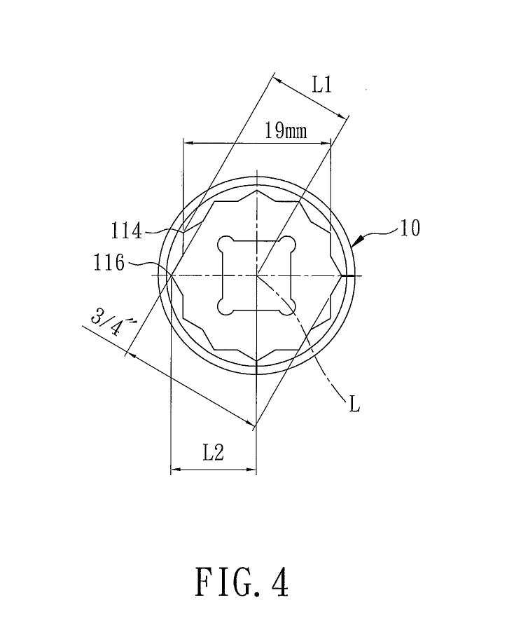

FIG. 4 shows the third preferred embodiment of a metric and English socket wrench according to this invention, which has a metric system size of 19 mm, and an English system size of ¾ inch. In this embodiment, the first distance (L1) is 10.9697 mm, and the second distance (L2) is 10.9985 mm, so that the ratio of the first distance (L1) to the second distance (L2) is 0.9973814.

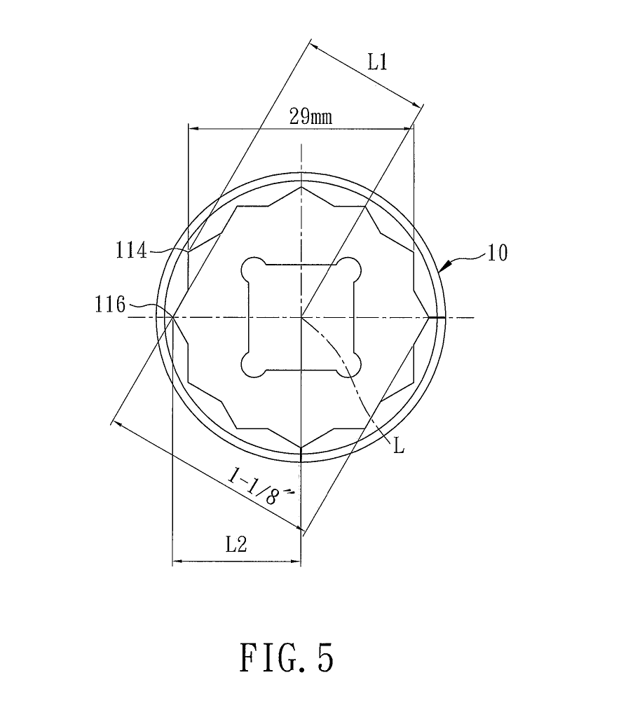

FIG. 5 shows the fourth preferred embodiment of a metric and English socket wrench according to this invention, which has a metric system size of 29 mm, and an English system size of 1+⅛ inch. In this embodiment, the first distance (L1) is 16.9697 mm, and the second distance (L2) is 10.4978 mm, so that the ratio of the first distance (L1) to the second distance (L2) is 1.0148747.

With this invention thus explained, it is apparent that numerous modifications and variations can be made without departing from the scope and spirit of this invention. It is therefore intended that this invention be limited only as indicated by the appended claims.

I claim:

1. A metric and English socket wrench adapted to be rotatable about an axis, said metric and English socket wrench comprising an inner peripheral surface disposed around the axis, said inner peripheral surface having a plurality of circumferentially spaced-apart first engaging portions, and a plurality of second engaging portions arranged alternately with said first engaging portions, each of said first engaging portions having two first engaging surfaces interconnected to form a V-shape, such that a first apex is disposed between said two first engaging surfaces and is adapted to be spaced apart from the axis by a first distance, each of said second engaging portions having two second engaging surfaces interconnected to form a V-shape, such that a second apex is disposed between said two second engaging surfaces and is adapted to be spaced apart from the axis by a second distance, ratio of said first distance to said second distance being more than 0.94 and less than 1.06.

2. The metric and English socket wrench as claimed in claim 1, further comprising an outer peripheral surface opposite to said inner peripheral surface, an end surface connected between said inner peripheral surface and said outer peripheral surface, and a first indication unit aligned with one of said first engaging portions and having a first marking portion disposed on said outer peripheral surface.

3. The metric and English socket wrench as claimed in claim 2, wherein said first indication unit further has a first connecting portion extending from said first marking portion toward the one of said first engaging portions.

4. The metric and English socket wrench as claimed in claim 3, wherein said first marking portion has a first size-indicating mark and a first pointer line extending from a top end of said outer peripheral surface toward said first size-indicating mark, said first connecting portion being linear, extending from a top end of said first pointer line, and being terminated at said first apex.

5. The metric and English socket wrench as claimed in claim 4, further comprising a second indication unit aligned with one of said second engaging portions and having a second marking portion disposed on said outer peripheral surface.

6. The metric and English socket wrench as claimed in claim 5, wherein said second indication unit further has a second connecting portion extending from said second marking portion toward the one of said second engaging portions.

7. The metric and English socket wrench as claimed in claim 6, wherein said second marking portion has a second size-indicating mark and a second pointer line extending from a top end of said outer peripheral surface toward said second size-indicating mark, said second connecting portion being linear, extending from a top end of said second pointer line, and being terminated at said second apex.
